(19) United States
(12) Patent Application Publication
(10) Pub. No.: US 2026/0236728 A1
(43) Pub. Date: Aug. 13, 2026

(54) RFID TAG PAIRING METHOD, APPARATUS, AND APPLICATION METHOD

(71) Applicant: Sichuan Kiloway Technologies Co., Ltd., Mianyang City (CN)

(72) Inventors: Junhua Mao, Mianyang City (CN); Fuchun HUA, Mianyang City (CN); Xiaodong Jiang, Mianyang City (CN)

(21) Appl. No.: 19/538,545

(22) Filed: Feb. 12, 2026

(30) Foreign Application Priority Data
Feb. 12, 2025 (CN) 202510153072.8

(51) Int. Cl. G06K 19/07; G06K 7/00; G06K 7/10

(52) U.S. Cl. CPC G06K 19/0723; G06K 7/0008; G06K 7/10356; G06K 7/10366

(57) ABSTRACT

An RFID tag pairing method includes: transmitting, by each master tag, a pairing signal to a corresponding slave tag, where the slave tag is a tag physically connected to the master tag, and each master tag is physically connected to one slave tag; performing traversal to obtain master tag information and slave tag information, and pairing the master tag and the slave tag that return the tag information in the same time slot, where the master tag and the corresponding slave tag communicate in the same communication time slot in a temporal collaboration manner. The reader-writer communicates with the master tag and the slave tag in the same communication time slot, thereby greatly improving communication efficiency, and effectively reducing time complexity in the tag pairing process.

### CROSS-REFERENCE TO RELATED APPLICATION

This patent application claims the benefit and priority of Chinese Patent Application 202510153072.8 filed with the China National Intellectual Property Administration on Feb. 12, 2025, the disclosure of which is incorporated by reference herein in its entirety as part of the present application.

### TECHNICAL FIELD

The present disclosure relates to the technical field of Radio Frequency Identification (RFID) tag communication, and in particular to an RFID tag pairing method, apparatus, and application method.

### BACKGROUND

RFID adopts a wireless communication manner between one reader-writer and multiple tags. The tags operate in a passive operating state, and power and commands come from the electromagnetic waves emitted by the reader-writer. The tags transmit their own information to the reader-writer by reflecting the electromagnetic waves emitted from the reader-writer.

It is necessary to obtain a pairing relationship between one tag and another tag among numerous RFID tags. A tag card-searching process has randomness. A tag only transmits tag information to a card reader only when the tag loads a random number into a slot counter and the slot counter is decremented to zero according to a card reader command. A pairing relationship between tags cannot be confirmed while obtaining all tag information.

At present, an existing solution involves generating a high voltage through a master tag, a slave tag changes its internal information after detecting the high voltage, and the slave tag notifies the changed information to the card reader, so that the card reader confirms a pairing relationship between these two tags. This solution has relatively low efficiency, and requires multiple repeated card searches.

The existing solution is specifically that assumed that there are N master tags, each correspondingly connected to N slave tags; a reader-writer first traverses the N master tags, selects a current master tag, and transmits a handshake high level to a slave tag that is physically connected to this maser tag; the reader-writer then traverses the N slave tags and reads level information received by the slave tags; and if the level information indicates a high level, then this slave tag is paired with the master tag, and the system associates the master tag with this slave tag and makes a record. This method has a high time complexity.

### SUMMARY

An objective of the present disclosure is to provide an RFID tag pairing method, apparatus, and application method, which can effectively reduce time complexity in a tag pairing process.

To achieve the above objective, the present disclosure provides the following technical solution:

According to a first aspect, the present disclosure provides an RFID tag pairing method. The RFID tag pairing method includes:
transmitting, by each master tag, a pairing signal to a corresponding slave tag, wherein the slave tag is a tag physically connected to the master tag, and each master tag is physically connected to one slave tag; and
performing traversal to obtain master tag information and slave tag information, and pairing the master tag and the slave tag that return the tag information in a same communication time slot, wherein the master tag and the corresponding slave tag communicate with a reader-writer in the same communication time slot in a temporal collaboration manner.

Optionally, each communication time slot comprises two stages; and in a process that the master tag and the corresponding slave tag communicate with the reader-writer in the same communication time slot in the temporal collaboration manner,
for each communication process, in a first stage of the communication time slot, the reader-writer communicates with the master tag through a Select/Query/Ack instruction to obtain the master tag information, and in a second stage of the communication time slot, the reader-writer communicates with the slave tag through a Req_RN/Read instruction to obtain the slave tag information.

Optionally, communication content in the first stage includes: identity information of the master tag; and communication content in the second stage includes: identity information of the slave tag.

Optionally, transmitting, by each master tag, the pairing signal to the corresponding slave tag specifically includes:
changing, by each master tag, a handshake signal between the master tag and the corresponding slave tag.

According to a second aspect, the present disclosure provides an RFID tag pairing apparatus. The RFID tag pairing apparatus includes: a reader-writer, a plurality of master tags, and a plurality of slave tags, where each master slave is physically connected to a slave tag.

The reader-writer is configured to:
transmit, by each master tag, a pairing signal to a corresponding slave tag, wherein the slave tag is a tag physically connected to the master tag; and
perform traversal to obtain master tag information and slave tag information, and pair the master tag and the slave tag that return the tag information in a same communication time slot, wherein the master tag and the corresponding slave tag communicate with the reader-writer in the same communication time slot in a temporal collaboration manner.

Optionally, the master tags and the slave tags are all RFID tags; and the reader-writer is an RFID reader-writer.

Optionally, the RFID tags are connected to the reader-writer through electromagnetic waves.

Optionally, the RFID tags are powered by the reader-writer, and receives an instruction from the reader-writer.

Optionally, the RFID tags transmit their own information to the reader-writer by reflecting electromagnetic waves of the reader-writer.

According to a third aspect, the present disclosure provides an application method for an RFID tag pairing apparatus. The application method for the RFID tag pairing apparatus includes:
respectively attaching master tags and slave tags to network ports and network cables, where there are several network ports and several network cables;
respectively physically connecting the master tags and the slaves on the corresponding network ports and network cables;
transmitting, by a reader-writer, a pairing signal through each master tag, to a corresponding slave tag, wherein the slave tag is a tag physically connected to the master tag, and the pairing signal is a level handshake signal which the master tag transmits to the slave tag through a physical connection;
performing traversal, by the reader-writer, to obtain master tag information and slave tag information, and pairing the master tag and the slave tag that return the tag information in a same communication time slot to obtain pairing information, wherein the master tag and the corresponding slave tag communicate with the reader-writer in the same communication time slot in a temporal collaboration manner; and
determining a pairing relationship between the network ports and the network cables according to the pairing information.

According to specific embodiments provided in the present disclosure, the present disclosure discloses the following technical effects:

The present disclosure provides an RFID tag pairing method, apparatus, and application method. The RFID tag pairing method includes: transmitting, by each master tag, a pairing signal to a corresponding slave tag, where the slave tag is a tag physically connected to the master tag, and each master tag is physically connected to one slave tag; and performing traversal to obtain master tag information and slave tag information, and pairing the master tag and the slave tag that return the tag information in the same communication time slot, where the master tag and the corresponding slave tag communicate with a reader-writer in the same communication time slot in a temporal collaboration manner. In this present disclosure, the reader-writer communicates with the master tag and the slave tag in the same communication time slot, thereby greatly improving communication efficiency, and effectively reducing time complexity in the tag pairing process.

### BRIEF DESCRIPTION OF THE DRAWINGS

In order to describe technical solutions in embodiments of the present disclosure more clearly, accompanying drawings required to be used in the embodiments will be simply introduced below. Apparently, the accompanying drawings in the following descriptions are merely some embodiments of the present disclosure. Those of ordinary skill in the art may further obtain other accompanying drawings according to these accompanying drawings without creative work.

FIG. 1 is a schematic diagram of a communication process between a tag and a reader-writer according to an embodiment of the present disclosure;

FIG. 2 is a schematic diagram of a physical connection pairing between two chips according to an embodiment of the present disclosure;

FIG. 3 is a schematic diagram of a handshake level signal according to an embodiment of the present disclosure;

FIG. 4 is a schematic diagram of a chip appearance and pads according to an embodiment of the present disclosure;

FIG. 5 is a schematic structural diagram of a tag according to an embodiment of the present disclosure;

FIG. 6 is a schematic diagram of an existing standard communication protocol according to an embodiment of the present disclosure;

FIG. 7 is a schematic diagram of a combination communication manner used in this embodiment according to an embodiment of the present disclosure;

FIG. 8 is a schematic diagram of an actual waveform of communication between a reader-writer and tags by device air-listening according to an embodiment of the present disclosure;

FIG. 9 is a schematic diagram of identifying and obtaining master tag information according to an embodiment of the present disclosure; and

FIG. 10 is a schematic diagram that a master tag notifies a slave tag through a physical connection and then the slave tag transmits its own tag information to a card reader according to an embodiment of the present disclosure.

### DETAILED DESCRIPTION OF THE EMBODIMENTS

Technical solutions in embodiments of the present disclosure are clearly and completely described in the following with reference to accompanying drawings in the embodiments of the present disclosure. Apparently, the described embodiments are merely part rather than all embodiments of the present disclosure. Based on the embodiments in the present disclosure, all other embodiments obtained by those of ordinary skill in the art without creative work fall within the protection scope of the present disclosure.

In an existing solution, it is assumed that there are N master tags, each correspondingly connected to N slave tags. A reader-writer first traverses the N master tags, selects one as a current master tag, and transmits a handshake high level to a slave tag physically connected to this maser tag. The reader-writer then traverses the N slave tags and reads level information received by the slave tags; and if the level information indicates a high level, then this slave tag is paired with the master tag, and the system associates the master tag with this slave tag and makes a record. The reader-writer selects a next master tag, and repeats the above two steps. It can be learned that a time complexity of this process is O(n²).

The present disclosure can improve efficiency for obtaining tag pairing information.

Application fields of the present disclosure include, but are not limited to, association and pairing of cables, optical fibers, network cables and device ports, and association and pairing between two articles.

Specific meanings of abbreviations used in this embodiment of the present disclosure and accompanying drawings are as follows:

Abbreviated terms, instructions, and annotations:
RFID: RFID is an abbreviation of Radio Frequency Identification, which means radio frequency identification. Its principle is that non-contact data communication is performed between a reader-writer and a tag to achieve the purpose of identifying a target.
EPC: EPC is an abbreviation of Electronic product code, which means an electronic product code.
DFN: DFN is an abbreviation of Dual Flat No-leads Package, which is an advanced packaging technology.
SOT: SOT (Small Outline Transistor) is a type of integrated circuit packaging.
CW: CW is an abbreviation of Continuous wave, which indicates a continuous wave.
Q: Slot counter parameter.
Handle: a handle, which is a 16-bit random number.
Select: a selection instruction.
Query: a card-searching instruction.
Queryrep: one of group reading card-searching instructions, which is used for decrementing a slot counter.
Queryadjust: one of group reading card-searching instructions, which is used for adjusting a Q value.
Ack: an acknowledgement instruction.
Req_RN: a random number request instruction.
Read: a read instruction.
PC: PC is an abbreviation of Protocol control, which indicates a protocol control bit used for determining an EPC length.
RN16: a 16-bit random number.
CRC16: a 16-bit cyclic redundancy check code.
Data: data.
GND: a ground wire.
RF: RF is an abbreviation of Radio Frequency, which indicates radio frequency.

To make above objective, features, and advantages of the present disclosure more apparent and comprehensible, the present disclosure is further described in detail below with reference to accompanying drawings and specific implementations.

### Embodiment 1

In an exemplary embodiment, an RFID tag pairing method is provided, including the following steps S1 and S2.

In S1, each master tag transmits a pairing signal to a corresponding slave tag, where the slave tag is a tag physically connected to the master tag, and each master tag is physically connected to one slave tag.

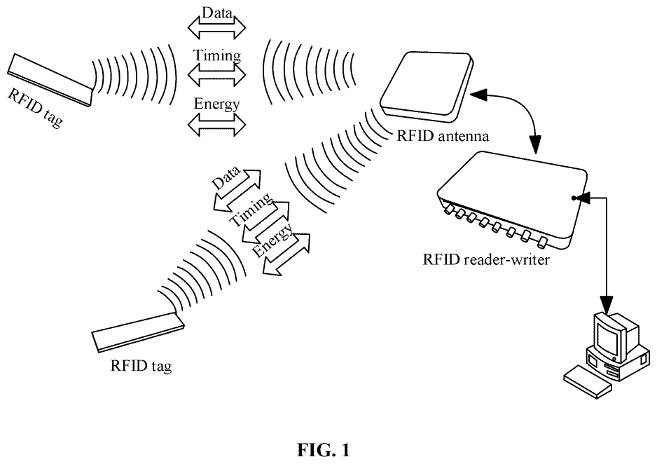

The step that each master tag transmits the pairing signal to the corresponding slave tag specifically includes: changing, by each master tag, a handshake signal between the master tag and the corresponding slave tag. A communication process between the tag and reader-writer is shown in FIG. 1.

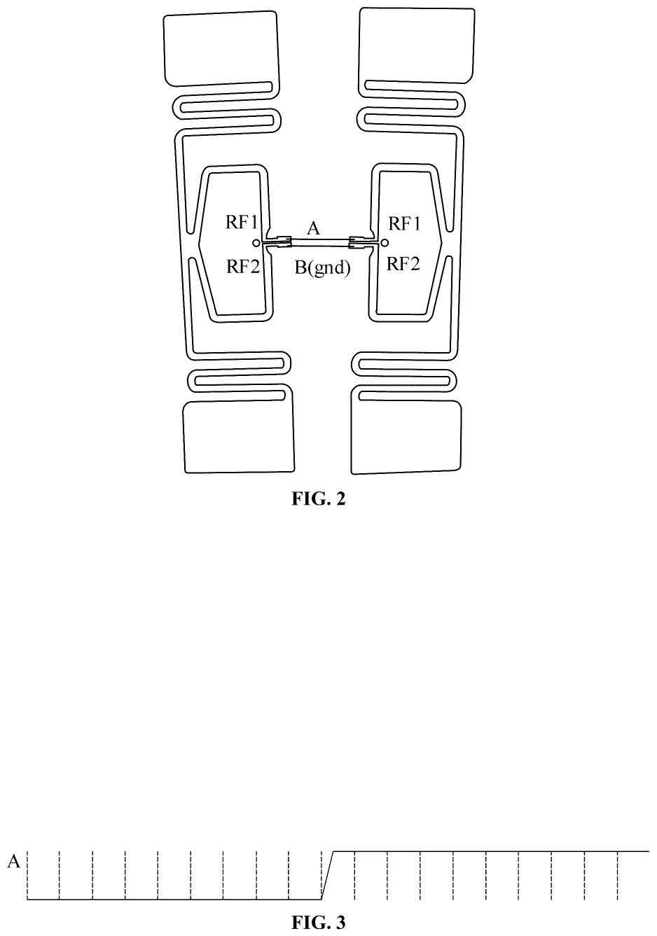

Referring to FIG. 2 and FIG. 3, in this embodiment, first, handshake is achieved through a physical connection between two tags. The physical connection between the two tags refers to that an on-site operator may insert a plurality of network cables into different network ports arbitrarily when this embodiment is applied to pairing between network cables and network ports, in this case, the network cables needs to be paired with the network ports, master tags and slave tags are respectively attached to the network cables and corresponding network ports, and handshake is achieved through the physical connection between the two tags.

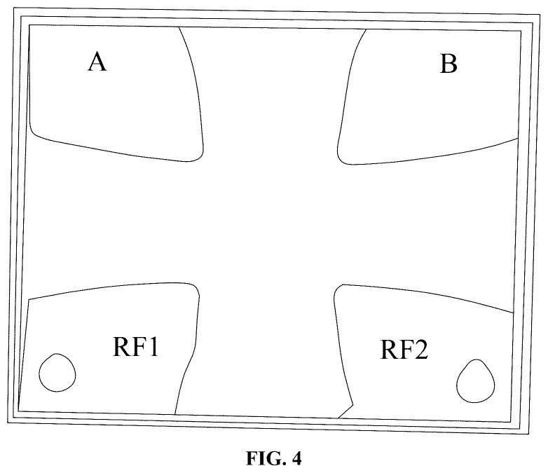

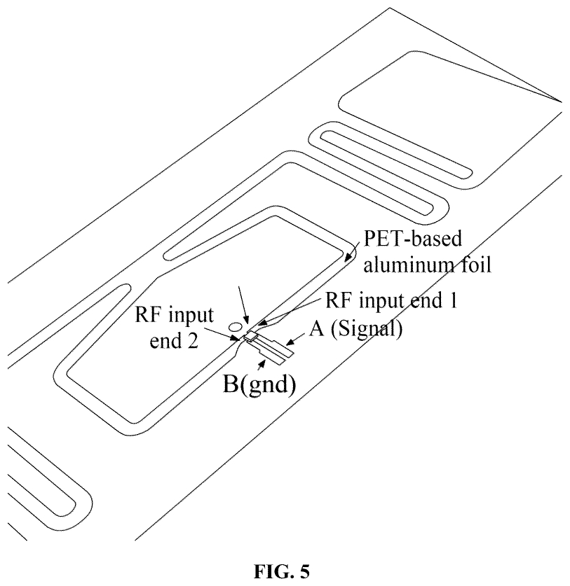

The tag is packaged with an antenna through conductive adhesive in a flip-chip configuration (which is a common form, but not limited to, there are gold wire bonding, DFN, SOT, etc., and in this embodiment, special clamps may be used to be respectively attached with articles need to be paired, such as a network cable and a network port, to be plugged together, so that double chips are interconnected to form a combination, thereby achieving a reliable electrical interconnection and communication condition). As shown in FIG. 4 and FIG. 5, FIG. 5 is a chip pad diagram, B is a common ground gnd of two tags, and A is a communication port of the two tags; for a master tag, A outputs a level signal; and for a slave tag, A receives a level signal.

In S2, master tag information and slave tag information are obtained by traversing, and the master tag and the slave tag that return the tag information in a same communication time slot are paired, where the master tag and the corresponding slave tag communicate with the reader-writer in the same communication time slot in a temporal collaboration manner.

Each communication time slot includes two stages; and the process that the master tag and the corresponding slave tag communicate with the reader-writer in the same communication time slot in the temporal collaboration manner specifically includes the following operations:
for each communication process, in a first stage of the communication time slot, the reader-writer communicates with the master tag through an instruction, such as Select/Query/Ack, to obtain the master tag information; and in a second stage of the communication time slot, the reader-writer communicates with the slave tag through an instruction, such as Req_RN/Read, to obtain the slave tag information. Communication content in the first stage includes: identity information of the master tag; and communication content in the second stage includes: identity information of the slave tag.

In this embodiment, a handshake is achieved through a physical connection between two tags, that is, after a card reader selects a tag through a card-searching instruction and obtains detailed information of this tag and after one of the tags (the master tag) is searched by the card reader, a paired tag (the slave tag) is notified through the physical connection, that is, this tag will change a level signal in the physical connection (this level signal is a handshake signal between the two tags), the other tag that is connected to this physical connection takes over communication with the card reader after detecting an variation in the level signal on this physical connection (during this period, the tag transmits its own information to the card reader), and ends the communication with the card reader until a next communication time slot begins. Association between information returned by the two tags is achieved, that is, the tag information of the two tags is obtained in the same communication time slot, and finally, pairing of the two tags is completed. In addition, in the next communication time slot, pairing of a next pair of tags is initiated, enabling multiple pairs of tags to be paired in the same inventory cycle.

An association communication process is described as follows.

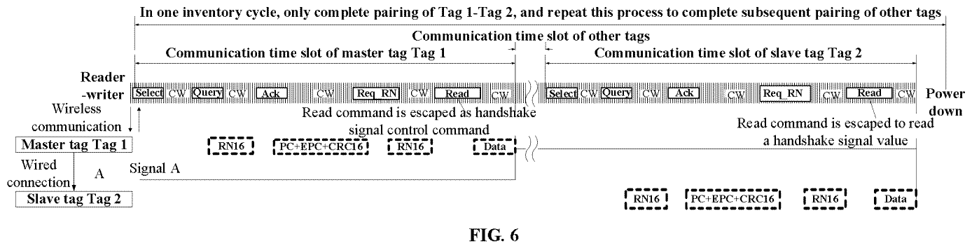

Referring to FIG. 6, an existing native standard communication protocol is as follows: a reader-writer performs sessions with each of a master tag tag1 and a slave tag tag2 in different time slots, and the reader-writer only communicates with one tag in the same communication time slot. In a case that multiple tags concurrently communicate with the reader-writer, selection of time slots for tag sessions has randomness. Therefore, precedence relationship and positions of the communication time slots of the master tag tag1 and the slave tag tag2 are indeterminate.

For a more detailed protocol, refer to EPC ® Radio-Frequency Identity Generation-2 UHF RFID Standard Release 3.0, Ratified, January 2024, a download link is EPC UHF Gen2 Air Interface Protocol |GS1, Link timing in section 6.3.1.6.

An existing pairing solution is limited by a native standard communication protocol, a handshake signal A is set to high in an inventory cycle of the master tag tag1, and then all slave tags are polled. When the reader-writer polls the slave tag tag2, and reads that an input level perceived by the slave stag tag2 is high, it is determined that the slave tag tag2 corresponds to the master tag tag1. When there are multiple master tags and multiple slave tags, a time complexity is O(n²).

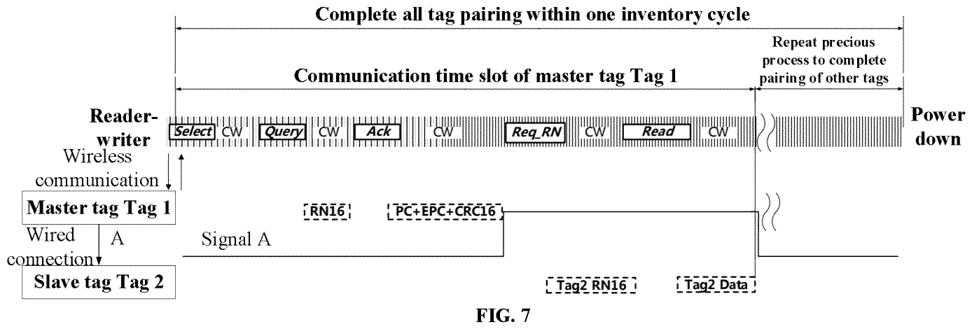

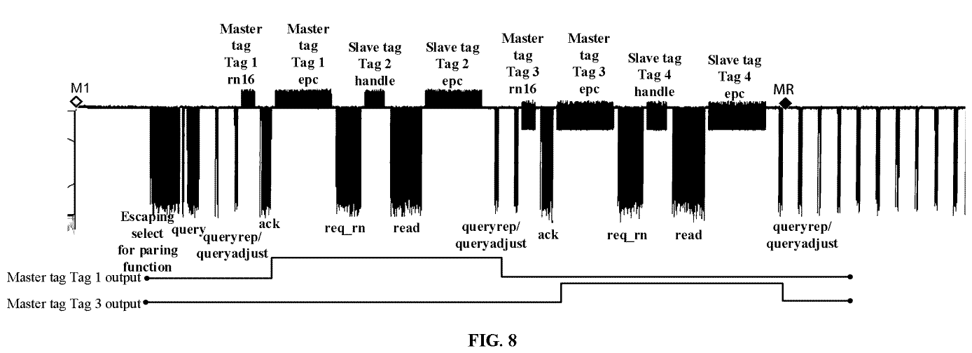

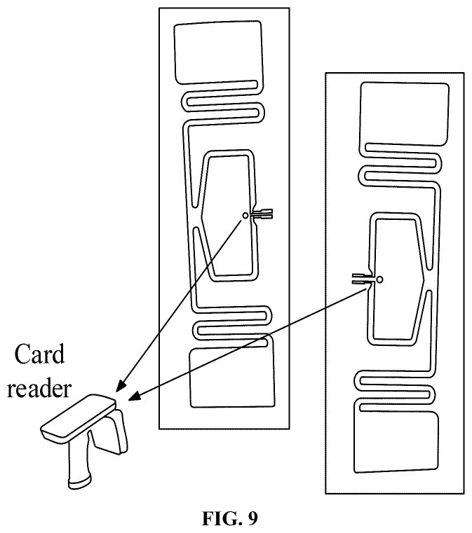

As shown in FIG. 7, in this embodiment, in a session of the master tag tag1, through handshake signal A, the previous instructions are all for the communication between the master tag tag1 and the reader-writer, and the slave tag tag2 takes over the communication with the reader-writer in subsequent Req_RN and Read instructions. In this case, the master tag tag1 does not communicate with the reader-writer any longer. In this case, a collaboration effect of the two tags is not different from communicating with one tag from a perspective of the reader-writer. Since EPC contains identity code information of the master tag tag1, Data contains identity code information of the slave tag tag2, and the master tag tag1 and the slave tag tag2 are in the same session, which indicates a binding relationship between the master tag tag1 and the master tag tag2. In this way, the efficiency of obtaining the binding relationship by the reader-writer is greatly improved, the binding relationship can be obtained by traversing once, and the time complexity is O(n). Req_RN is a protocol instruction name for requesting a random number. Read instruction is a read instruction. EPC is a unique article identifier. Data is data. Handle is a handle. To facilitate understanding, an actual waveform of communication between the reader-writer and tags using device air-listening is shown in FIG. 8.

This combination of two tags communicates with the reader-writer respectively through their respective antennas in a communication process (the reader-writer does not distinguish the two tags based on which tag antenna returns an acknowledgement, but defines a tag individual communicating with the reader-writer based on return timing and a random number (handle) of the tag). However, an approach of using a single tag for manifesting a collaborative communication effect has innovativeness, so that the reader-writer can quickly determine the binding relationship between the two tags. This embodiment may alternatively be regarded as a hacker approach to the native communication protocol, achieving an unexpected effect when the native communication protocol is initially formulated.

In short, in this embodiment, after one of the tags is searched by the card reader, the paired tag is notified through the physical connection, a handshake is achieved through the physical connection between the two tags, that is, after a card reader selects a tag as a master tag through card-searching polling and obtains detailed information of this tag, this tag will change a level signal in the physical connection (this level signal is a handshake signal between the two tags), and this level signal is transmitted to the slave tag as a handshake signal. The slave tag physically connected takes over subsequent communication between the master tag and the reader-writer after receiving the handshake signal, and returns its own tag information to the reader-writer, thereby achieving associated transmission of information returned by the two tags, and completing pairing of the two tags.

This embodiment is not limited to communication protocols and instruction types shown in the figures, but focuses on the timing and mechanism through which the combination operates collaboratively like a single tag via the connecting cable.

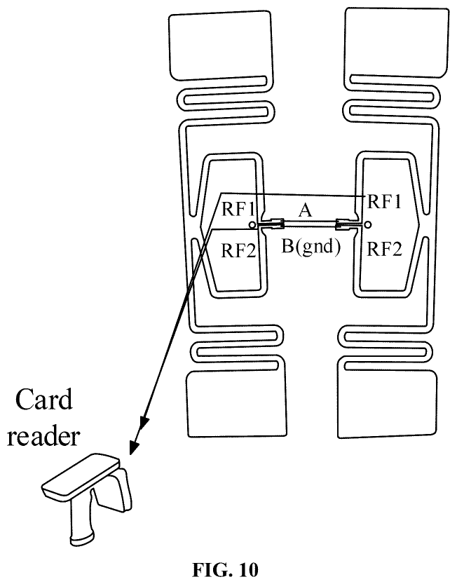

In short, the reader-writer in this embodiment identifies and obtains master tag information from numerous tags, the master tag notifies the slave tag through the physical connection, and the slave tag then transmits its own tag information to the card reader, so that the card reader obtains the pairing relationship between the master tag and the slave tag, as shown in FIG. 9 and FIG. 10.

### Embodiment 2

According to an exemplary embodiment, an RFID tag pairing apparatus is provided, including: a reader-writer, a plurality of master tags, and a plurality of slave tags, where each master slave is physically connected to a slave tag.

The reader-writer is configured to:
transmit, through each master tag, a pairing signal to a corresponding slave tag, where the slave tag is a tag physically connected to the master tag; and
perform traversal to obtain master tag information and slave tag information, and pair the master tag and the slave tag that return the tag information in the same communication time slot, where the master tag and the corresponding slave tag communicate with the reader-writer in the same communication time slot in the temporal collaboration manner.

The master tags and the slave tags are all RFID tags; and the reader-writer is an RFID reader-writer.

The RFID tags are connected to the reader-writer through electromagnetic waves.

The RFID tags are powered by the reader-writer, and receives an instruction from the reader-writer.

The RFID tags transmit their own information to the reader-writer by reflecting electromagnetic waves of the reader-writer.

### Embodiment 3

In an exemplary embodiment, an application method for the RFID tag pairing apparatus is provided, including the following steps A1 to A4.
In A1, master tags and slave tags are respectively attached to network ports and network cables, where there are several network ports and several network cables.
In A2, the master tags and the slaves on the corresponding network ports and network cables are physically connected with each other respectively.
In A3, a reader-writer transmits a pairing signal to a corresponding slave tag through each master tag, where the slave tag is a tag physically connected to the master tag, and the pairing signal is a level handshake signal which the master tag transmits to the slave tag through a physical connection.
In A4, the reader-writer performs traversal to obtain master tag information and slave tag information, and pairs the master tag and the slave tag that return the tag information in the same communication time slot to obtain pairing information, where the master tag and the corresponding slave tag communicate with the reader-writer in the same communication time slot in the temporal collaboration manner.

Those of ordinary skill in the art can understand that all or part of processes in the above method embodiments may be implemented by a computer program instructing related hardware, and the computer program may be stored in a non-volatile computer-readable storage medium. When the computer program is executed, the processes of each method embodiment as described above may be included. Any reference to a memory, a database, or another medium used in various embodiments provided in the present disclosure may include at least one of a non-volatile and volatile memory. The non-volatile memory may include a Read-Only Memory (ROM), a magnetic tape, a floppy disk, a flash memory, an optical memory, a high-density embedded nonvolatile memory, a Resistive Random Access Memory (ReRAM), a Magnetoresistive Random Access Memory (MRAM), a Ferroelectric Random Access Memory (FRAM), a Phase Change Memory (PCM), a graphene memory, and the like. The volatile memory may include a Random Access Memory (RAM) or an external cache memory. By way of illustration but not limitation, the RAM may be in a variety of forms such as a Static Random Access Memory (SRAM), or a Dynamic Random Access Memory (DRAM).

The database involved in various embodiments provided by this disclosure may include at least one of a relational database and a non-relational database. The non-relational database may include, but is not limited to, a blockchain-based distributed database, and the like. The processor involved in various embodiments provided by this disclosure may be, but is not limited to, a general-purpose processor, a central processing unit, a graphics processing unit, a digital signal processor, a programmable logic device, a quantum computing-based data processing logic device, and the like.

Various technical features of the above embodiments may be arbitrarily combined. To make the description concise, not all possible combinations of the various technical features in the above embodiments are described. However, combinations of these technical features are considered to be in a range described in this specification as long as there is no conflict.

Herein, specific examples are used for describing principles and implementations of the present disclosure. The descriptions of the above embodiments are merely intended to help understand the method of the present disclosure and a core idea thereof. In addition, those of ordinary skill in the art may make modifications based on the idea of the present disclosure with respect to specific implementations and application scopes. In conclusion, the content of this specification is not to be construed as a limitation to the present disclosure.

What is claimed is:

1. A Radio Frequency Identification (RFID) tag pairing method, comprising:
transmitting, by each master tag, a pairing signal to a corresponding slave tag, wherein the slave tag is a tag physically connected to the master tag, and each master tag is physically connected to one slave tag; and
performing traversal to obtain master tag information and slave tag information, and pairing the master tag and the slave tag that return the tag information in a same communication time slot, wherein the master tag and the corresponding slave tag communicate with a reader-writer in the same communication time slot in a temporal collaboration manner.

2. The RFID tag pairing method according to claim 1, wherein each communication time slot comprises two stages; and in a process that the master tag and the corresponding slave tag communicate with the reader-writer in the same communication time slot in the temporal collaboration manner,
for each communication process, in a first stage of the communication time slot, the reader-writer communicates with the master tag through a Select/Query/Ack instruction to obtain the master tag information, and in a second stage of the communication time slot, the reader-writer communicates with the slave tag through a Req_RN/Read instruction to obtain the slave tag information.

3. The RFID tag pairing method according to claim 2, wherein communication content in the first stage comprises: identity information of the master tag; and communication content in the second stage comprises: identity information of the slave tag.

4. The RFID tag pairing method according to claim 1, wherein transmitting, by each master tag, the pairing signal to the corresponding slave tag comprises:
changing, by each master tag, a handshake signal between the master tag and the corresponding slave tag.

5. A Radio Frequency Identification (RFID) tag pairing apparatus, comprising: a reader-writer, a plurality of master tags, and a plurality of slave tags, wherein each of the plurality of master tags is physically connected to one of the plurality of slave tags;
the reader-writer is configured to:
transmit, by each master tag, a pairing signal to a corresponding slave tag, wherein the slave tag is a tag physically connected to the master tag; and
perform traversal to obtain master tag information and slave tag information, and pair the master tag and the slave tag that return the tag information in a same communication time slot, wherein the master tag and the corresponding slave tag communicate with the reader-writer in the same communication time slot in a temporal collaboration manner.

6. The RFID tag pairing apparatus according to claim 5, wherein
the master tags and the slave tags are all RFID tags; and
the reader-writer is an RFID reader-writer.

7. The RFID tag pairing apparatus according to claim 6, wherein
the RFID tags are connected to the reader-writer through electromagnetic waves.

8. The RFID tag pairing apparatus according to claim 6, wherein
the RFID tags are powered by the reader-writer, and receives an instruction from the reader-writer.

9. The RFID tag pairing apparatus according to claim 6, wherein
the RFID tags transmit their own information to the reader-writer by reflecting electromagnetic waves of the reader-writer.

10. An application method for a Radio Frequency Identification (RFID) tag pairing apparatus, comprising:
respectively attaching master tags and slave tags to network ports and network cables, wherein there are several network ports and several network cables;
respectively physically connecting the master tags and the slaves on the corresponding network ports and network cables;
transmitting, by a reader-writer, a pairing signal through each master tag, to a corresponding slave tag, wherein the slave tag is a tag physically connected to the master tag, and the pairing signal is a level handshake signal which the master tag transmits to the slave tag through a physical connection;
performing traversal, by the reader-writer, to obtain master tag information and slave tag information, and pairing the master tag and the slave tag that return the tag information in a same communication time slot to obtain pairing information, wherein the master tag and the corresponding slave tag communicate with the reader-writer in the same communication time slot in a temporal collaboration manner; and
determining a pairing relationship between the network ports and the network cables according to the pairing information.
